(19) United States
(12) Patent Application Publication
(10) Pub. No.: US 2024/0125179 A1
(43) Pub. Date: Apr. 18, 2024

(54) RUNG WITH A FLARED BEADED JOINT

(71) Applicant: WERNER Co., Greenville, IL (US)

(72) Inventors: Patrick Michael McAuliffe, Chicago, IL (US); Thomas Ward Parker, Jamestown, PA (US)

(21) Appl. No.: 18/380,991

(22) Filed: Oct. 17, 2023

Related U.S. Application Data
(60) Provisional application No. 63/416,911, filed on Oct. 17, 2022.

(51) Int. Cl. E06C 7/08; E06C 1/06

(52) U.S. Cl. CPC E06C 7/084; E06C 1/06

(57) ABSTRACT

Provided herein are ladders having a flared beaded joint to couple a rung to a rail of the ladder. In some embodiments, a ladder comprises a rail having a web. The web has a first side and a second side. The ladder further includes a rung coupled to the rail via a flared beaded joint. In some configurations, flared beaded joints are disposed at each end of the rung. The flared beaded joint includes a first bead on the first side of the web and a second bead on the second side of the web. The first bead includes a first flange portion and a second flange portion. The first flange portion directly abuts the first side of the web. At least a portion of the second flange portion is disposed at an angle relative to the first flange portion to flare an end of the rung.

### CROSS-REFERENCE TO RELATED APPLICATIONS

This application claims the benefit of U.S. Provisional Application No. 63/416,911 filed Oct. 17, 2022, which is incorporated herein by reference in its entirety.

### TECHNICAL FIELD

This disclosure relates generally to ladders and, more specifically, to rungs for ladders.

### BACKGROUND

Ladders, such as extension ladders, include a plurality of rungs disposed between the ladder rails. The rungs are secured to the rails at a plurality of rung to rail joints. The rung to rail joints of a ladder bear the ladder load, such as the weight of a user climbing a ladder. Accordingly, the rung to rail joint is important to the load bearing capability of a ladder.

In some examples, the rung to rail joint of a ladder may be a beaded joint formed by folding material into a bead-like flange. As such, strengthening, beaded joints that form the rung to rail joints of a ladder may be desirable.

### BRIEF DESCRIPTION OF DRAWINGS

Disclosed herein are ladders or similar structures having a flared rung described in the following detailed description.

FIG. 1 comprises a perspective view of a ladder having a rung with a flat flange joint;

FIG. 2 comprises a cross-sectional view of the flat flange joint on the ladder of FIG. 1;

FIG. 3 comprises a perspective view of a ladder with a rung having a flared beaded joint, in accordance with a first embodiment;

FIG. 4 comprises a cross-sectional view the flared beaded joint of the ladder of FIG. 3;

FIG. 5 comprises a front elevation view of the rung on the ladder of FIG. 3;

FIG. 6 comprises a cross sectional view of the flared rung of FIG. 5 taken along line B-B;

FIG. 7 comprises a right side view of the rung of FIG. 3;

FIG. 8 comprises a perspective view of a rung having a flared beaded joint with a non-circular cross section, in accordance with a second embodiment;

FIG. 9 comprises a front elevation view of the rung of FIG. 8;

FIG. 10 comprises a right side view of the rung of FIG. 8;

FIG. 11 comprises a cross-sectional view of the rung of FIG. 9 taken along line C-C;

FIG. 12 comprises a cross-sectional view of the rung of FIG. 9 taken along line D-D;

FIG. 13 comprises a top plan view of the rung of FIG. 8;

FIG. 14 comprises a cross-sectional view of the rung of FIG. 13 taken along line E-E;

FIG. 15 comprises a perspective view of a rung having a flared beaded joint with more than one flare angle, in accordance with a third embodiment;

FIG. 16 comprises a front elevation view of the rung of FIG. 15;

FIG. 17 comprises a right side view of the rung of FIG. 15;

FIG. 18 comprises a top plan view of the rung of FIG. 15;

FIG. 19 comprises a cross-sectional view of the rung of FIG. 18 taken along line F-F;

FIG. 20 comprises a flow diagram of a method of forming a rung having a flared beaded joint, in accordance with some embodiments;

FIG. 21 comprises a perspective view of a mandrel and a first end of a rung, in accordance with some embodiments;

FIG. 22 comprises a perspective view of the mandrel and a second end of the rung of FIG. 21; and

FIG. 23 comprises the mandrel engaging the second end of the rung of FIG. 22 to form a flared beaded joint.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present teachings. Also, common but well-understood elements that are useful or necessary in a commercially feasible embodiment are often not depicted in order to facilitate a less obstructed view of these various embodiments of the present teachings. Certain actions and/or steps may be described or depicted in a particular order of occurrence while those skilled in the art will understand that such specificity with respect to sequence is not actually required.

### DETAILED DESCRIPTION

Provided herein is a ladder including a rung with one or more flared beaded joints to reinforce the rung to rail joint of the ladder. The flared beaded joint secures the rung to a rail of the ladder. By one approach, the rung includes a flare beaded joint adjacent to each end thereof. The ladder, for example, may be an extension ladder that includes a plurality of rungs.

In one illustrative approach, the flared beaded joint includes a first or inner bead disposed on an inner side of the rail. The flared beaded joint further includes a second or outer bead disposed on an outer side of the rail. The first bead includes a first flange portion and a second flange portion. The first flange portion directly abuts the inner side of the rail. The second flange portion is disposed at an angle relative to the first flange portion to flare an end of the rung. So configured, the flared beaded joint acts as a buttress or reinforcement for the rung to rail joint.

The flared beaded joints described herein may allow for weight reduction of the rungs of a ladder while still achieving strength and rigidity at the rung to rail joints, for example, to comply with strength and rigidity testing per ANSI codes. The flared beaded joints described herein may resist being deflected away from a direction that is perpendicular to the rail when a load is applied to the rung. It is contemplated that flared beaded joints may resist such deflection up to 15 percent better than non-flared beaded joints.

In some approaches, the flared beaded joint may be annular, with at least a portion of the flared beaded joint having an inner diameter that is larger than an inner diameter of the rung. In this manner, the flared beaded joint may provide additional contact area between the rung and the rail to increase the cantilever strength of the rung to rail joint. It is contemplated that the flared beaded joints described herein may increase the cantilever strength of a rung to rail joint by 10-20 percent as compared to traditional non-flared beaded joints or flat flange joints. Further, flaring an end of the rung to a larger diameter at the beaded joint, rather than increasing the diameter of the entire rung, may increase cantilever strength while conserving material to reduce the weight and cost of the rung.

In some configurations, one or more ladder rungs have a non-circular or non-ovular section. For example, the one or more rungs may be substantially circular or oval in configuration with a portion thereof being flat.

In addition, one or more rungs may have a cross section that is not uniform along a length of the rung. In some configurations, a rung at the ends thereof may have a first cross section and between the ends (e.g., along a center portion or body of the rung) may have a second cross section that is distinct from the first cross section. For example, a rung may have ends with a generally circular cross section and a center portion that is substantially circular but also includes a flat portion thereof. In another example, a rung may have ends with a generally oblong cross section and a center portion that is substantially circular or D-shaped.

Though the flared beaded joints are depicted on rungs of a ladder, it is also contemplated that the flared beaded joints may be used to reinforce a rung to rail joint in any railed structure such as, for example, a scaffold or a work platform.

In some aspects, a ladder comprises a rail that includes a first flange spaced from a second flange by a web. The web has a first or inner side and a second or outer side. The ladder also includes at least one rung coupled to the web of the rail via a flared beaded joint. The flared beaded joint includes a first bead and a second bead. The first bead is disposed the first side of the web. The second bead is disposed on the second side of the web. The first bead includes a first flange portion and a second flange portion. The first flange portion directly abuts the first side of the web. At least a portion of the second flange portion is disposed at an angle relative to the first flange portion to flare an end of the at least one rung.

The first flange portion of the flared beaded joint may be an annular ring that has an inner diameter larger than an inner diameter of the at least one rung.

The angle of the second flange portion of the first bead relative to the first flange portion of the first bead and/or relative to the web of the rail may be between about 15 degrees to about 75 degrees.

The second bead may include a first flange portion and a second flange portion. The first flange portion of the second bead may directly abut the second side of the web. Further, the second flange portion of the second bead may directly abut the first flange portion of the second bead to form a flat bead with no flare.

In some aspects, a ladder comprises a rail that includes a web. The web has a first or inner side and a second or outer side. The ladder further includes at least one rung coupled to the web of the rail via a beaded joint. The beaded joint includes a first bead on the first side of the web and a second bead on the second side of the web. The first bead has a first annular flange portion that directly abuts the first side of the web. The first bead further includes a second annular flange portion. The second annular flange portion includes a first section that is disposed at a first angle relative to the first annular flange portion.

The second annular flange portion may further include a second section that is disposed at a second angle relative to the first annular flange portion, wherein the first angle is different than the second angle.

The at least one rung may have a first cross section disposed adjacent to the web of the rail and a second cross section disposed a distance from the web. The first and second cross sections may be different from one another. In some aspects, the first and second cross sections may be different shapes. For example, the first cross section may be generally oblong, and the second cross section may be generally circular or D-shaped. In some aspects, the first and second cross sections may be different sizes. For example, the first cross section may be larger than the second cross section.

In some aspects, a ladder comprises a first rail having a first web. The ladder also includes a second rail parallel to and spaced from the first rail. The second rail has a second web. The ladder further includes at least one rung having a first end and a second end. The first end of the at least one rung is coupled to the first web via a first beaded joint. The second end of the at least one rung is coupled to the second web via a second beaded joint. The first beaded joint has a first outer flange portion disposed at an angle relative to the first web. The second beaded joint having a second outer flange portion disposed at an angle relative to the second web.

The terms and expressions used herein have the ordinary technical meaning as is accorded to such terms and expressions by persons skilled in the technical field as set forth above except where different specific meanings have otherwise been set forth herein. The word “or” when used herein shall be interpreted as having a disjunctive construction rather than a conjunctive construction unless otherwise specifically indicated. The terms “coupled,” “fixed,” “attached to,” and the like refer to both direct coupling, fixing, or attaching, as well as indirect coupling, fixing, or attaching through one or more intermediate components or features, unless otherwise specified herein.

The singular forms “a”, “an”, and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms such as “about”, “approximately”, and “substantially”, are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin.

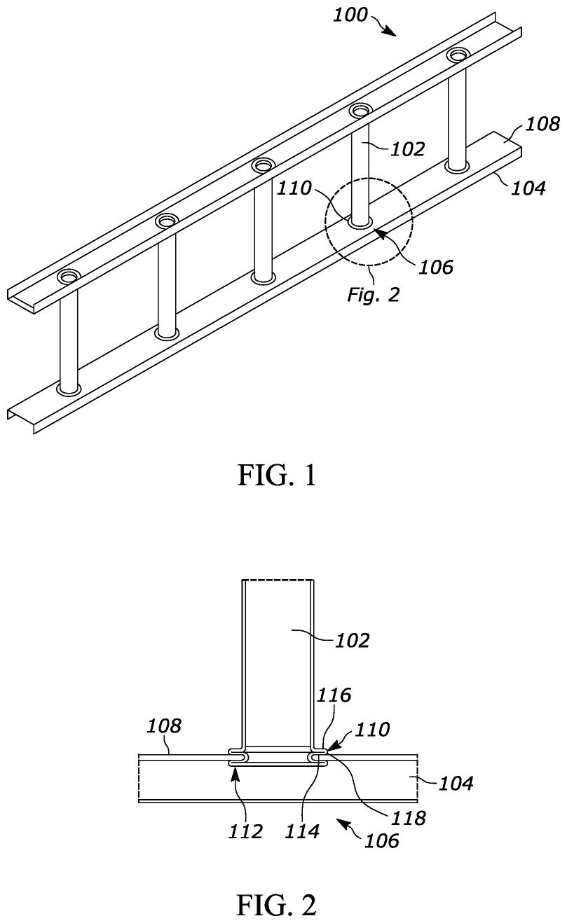

Referring now to the drawings, FIGS. 1 and 2 show a ladder 100 that includes a rung 102 with a flat flange joint 106. The flat flange joint 106 is not flared or tapered. The rung 102 is coupled to a rail 104 of the ladder 100. The rail 104 includes a web 108. The flat flange joint 106 is disposed at an intersection of the rung 102 with the web 108 of the rail 104. The flat flange joint 106 comprises a first flange 110 and a second flange 112. The first flange 110 includes a first flange portion 114 and a second flange portion 116 coupled together at a bend 118. The first flange portion 114 of the first flange 110 directly abuts the web 108. The second flange portion 116 directly abuts the first flange portion 114. The bend 118 is approximately 180 degrees or U-shaped such that the first flange portion 114 is generally parallel to the second flange portion 116. As a result, the second flange portion 116 is not disposed at an angle relative to the second flange portion 116 and the first flange 110 is not flared.

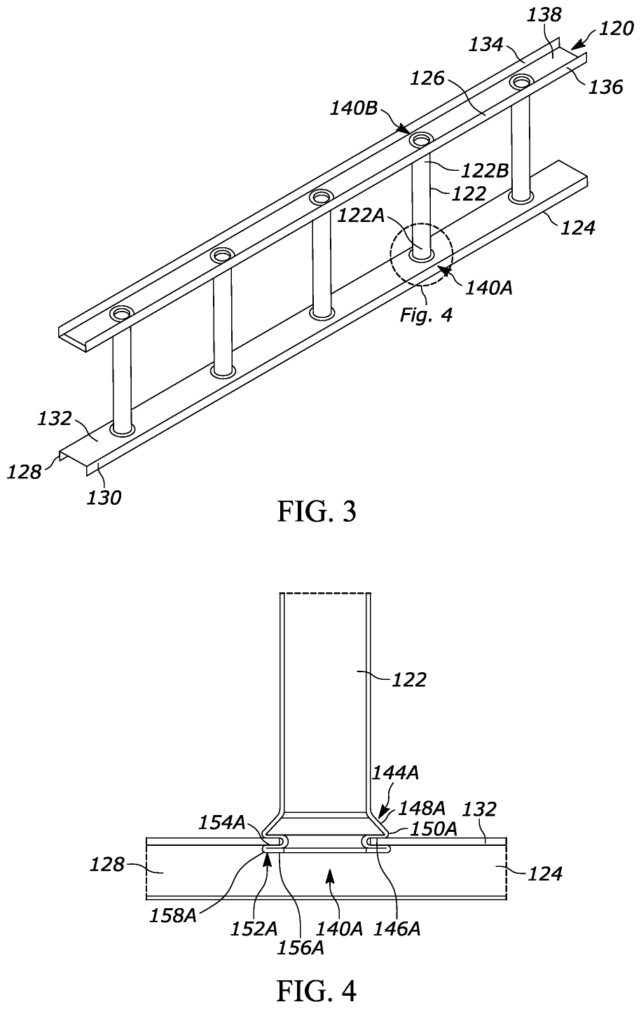

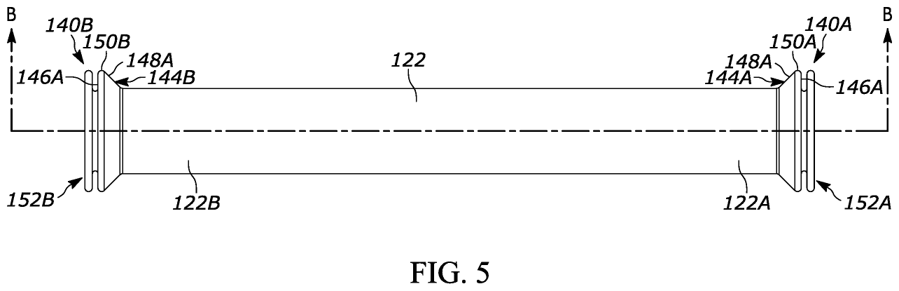

By contrast, FIGS. 3-7 show a ladder 120 that includes a rung 122 with flared beaded joints 140A, 140B, in accordance with a first embodiment. The rung 122 is coupled to a first rail 124 and a second rail 126 of the ladder 120. In FIGS. 5-7 the rails 124,126 (and webs thereof) of the ladder 120 are not shown.

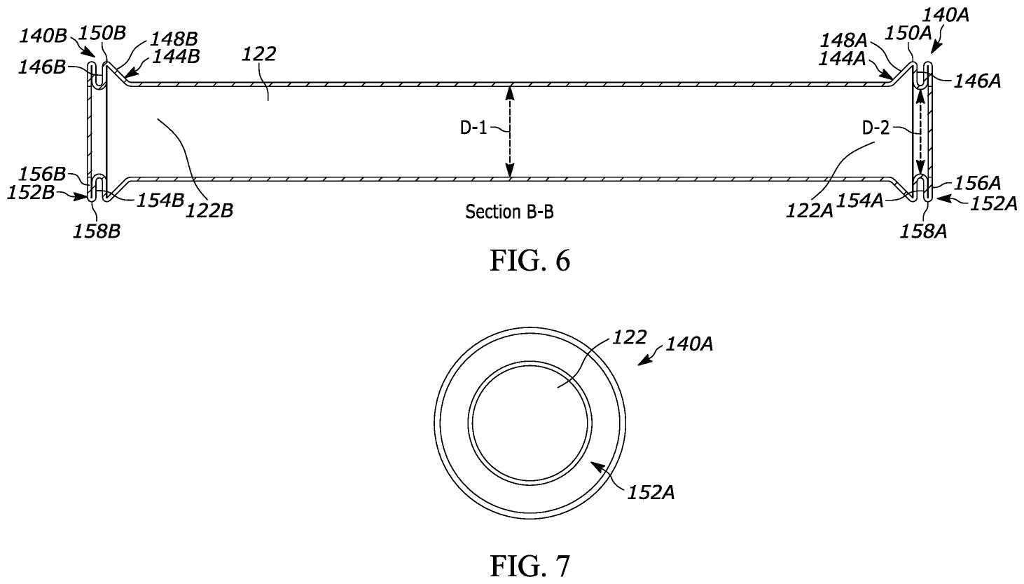

The rung 122 is hollow and has an inner diameter D-1, which is illustrated in FIG. 6. As shown in FIGS. 3 and 7, the rung 122 has a cross-sectional shape that is generally circular along its length. Though, it is contemplated that the rung 122 may have any suitable cross-sectional shape such as a triangular, oblong, D-shaped, square, or rectangular. In some examples, the rung 122 is a single piece of material, such as a single piece extrusion. Further, as noted above, the rung 122 may have a first cross section at one point along the rung and a second, distinct cross section at another point along the rung.

When installed, the rung 122 is disposed between the first rail 124 and the second rail 126. The rung 122 has a first end 122A coupled to the first rail 124 and a second end 122B coupled to the second rail 126. The first rail 124 includes a first flange 128 spaced from a second flange 130 by a first web 132. The second rail 126 also includes a first flange 134 spaced from a second flange 136 by a second web 138. The first flared beaded joint 140A is disposed at the first end 122A of the rung 122. The second flared beaded joint 140B is disposed at the second end 122B of the rung.

The first flared beaded joint 140A comprises a first bead 144A and a second bead 152A. The first bead 144A includes a first (or inner) flange portion 146A and a second (or outer) flange portion 148A coupled together at a first bend 150A. The first bend 150A is less than 180 degrees and may be between about 100 degrees and about 170 degrees, between about 105 degrees and about 165 degrees, or, in some aspects, between about 110 degrees and about 160 degrees. Accordingly, the second flange portion 148A is disposed at an angle relative to the first flange portion 146A and/or at an angle relative to the web of the rail to flare the first end 122A of the rung 122. In some approaches, the second flange portion 148A is disposed at an angle between about 10 degrees and about 80 degrees, between about 15 degrees and about 75 degrees, or between about 20 degrees and about 60 degrees relative to the first flange portion 146A and/or relative to the web of the rail.

The angle of the first flange portion 154A relative to the second flange portion 156A and/or relative to the web of the rail may also be referred to herein as the flare angle of the flared beaded joint 140A. In some approaches, the flare angle is selected to balance the thinning of the rung material that may occur due to the flaring of the flared beaded joint 140A and with the buttressing effect that may occur from increasing the flare angle.

The second bead 152A includes a first flange portion 154A and a second flange portion 156A coupled together at a bend 158A. The bend 158A may be approximately 180 degrees or U-shaped such that the first flange portion 154A of the second bead 152A is approximately parallel to the second flange portion 156A of the second bead 152A.

The first flange portion 146A of the first bead 144A directly abuts a first side (or an inner or inboard side) of the first web 132 of the first rail 124. The first flange portion 154A of the second bead 152A directly abuts a second side (or an outer or outboard side) of the first web 132. So configured, the first flange portion 154A of the second bead 152A and the first flange portion 146A of the first bead 144A sandwich the first web 132 to secure the rung 122 to the first rail 124.

In the first flared beaded joint 140A, the first flange portion 146A of the first bead 144A is an annular disc with an open central portion. Similarly, the first flange portion 154A and the second flange portion 156A of the second bead 152A are annular discs. The first flange portion 146A of the first bead 144A, the first flange portion 154A of the second bead 152A, and the second flange portion 156A of the second bead 152A have an inner diameter D-2. The inner diameter D-2 is approximately the same as the inner diameter D-1.

The second flared beaded joint 140B is disposed at the second end 122B of the rung 122 at an intersection of the rung 122 with the second web 138 of the second rail 126. The second flared beaded joint 140B is generally the same as the first flared beaded joint 140A. Elements of the second flared beaded joint 140B that are similar to those of the first flared beaded joint 140A have been given similar reference numbers with a “B” instead of an “A” and only general differences will be discussed. For example, the first flange portion 146A described in the first flared beaded joint 140A is numbered as 146B in the second flared beaded joint 140B.

In the first embodiment, the flare that is present on the first beads 144A, 144B of the flared beaded joints 140A, 140B extends 360 degrees around the perimeter of the rung 122. Accordingly, as illustrated in FIG. 7, the cross-sectional shapes of the flared beaded joints 140A, 140B are generally circular.

One or more rungs of the ladder 120 may be coupled to the rails 124, 126 using flared beaded joints, for example, the flared beaded joints 140A, 140B. In some examples, all of the rungs of the ladder 120 may include flared beaded joints. In yet other examples, only the rungs of the ladder 120 that are present in a work zone where a user is likely to stand for extended periods of time may include flared beaded joints.

It is contemplated that the flared beaded joints 140A, 140B may act as a gusset to reinforce the joints where the rung 122 is coupled to the rails 124, 126. This reinforcement may increase the cantilever strength of the rung to rail joints. It is contemplated that the flared beaded joints 140A, 140B may increase the cantilever strength of the rung to rail joint, for example, without increasing the rung diameter. In this manner, incorporating the flared beaded joints 140A, 140B may increase the cantilever strength while conserving material usage.

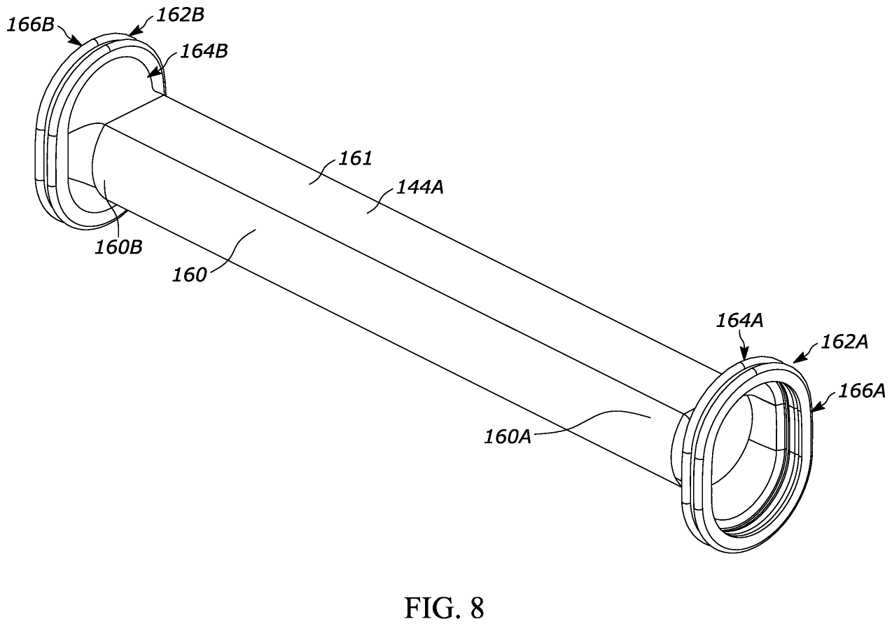

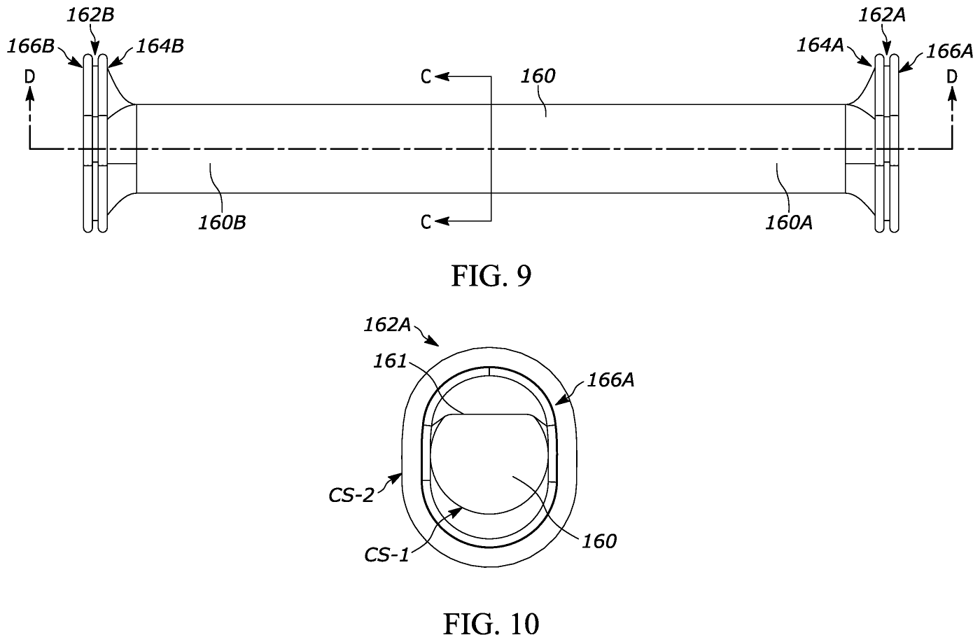

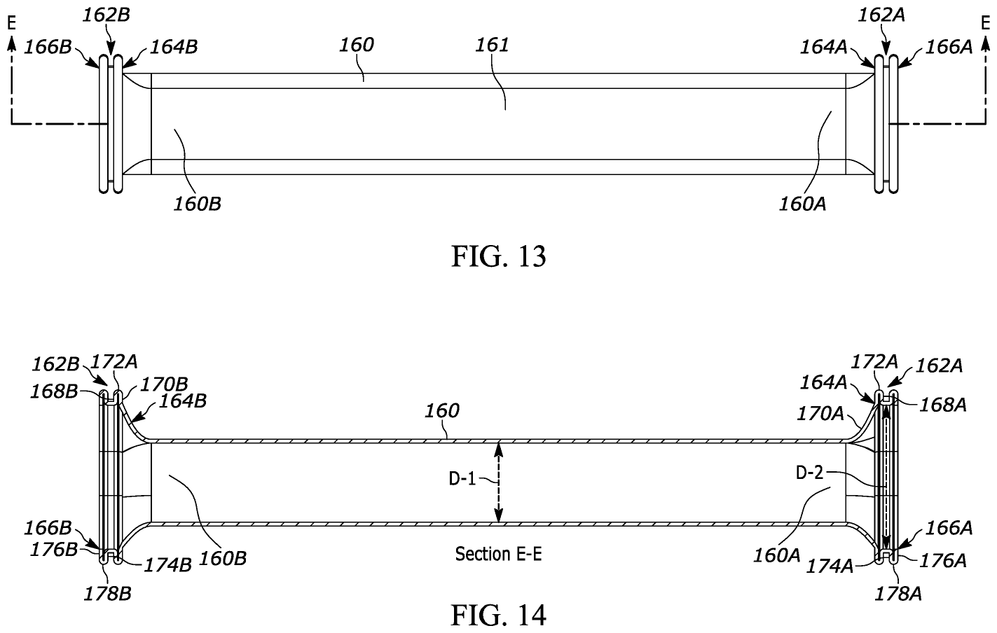

FIGS. 8-14 show a rung 160 with flared beaded joints 162A, 162B, in accordance with a second embodiment. The first flared beaded joint 162A is disposed at a first end 160A of the rung 160. The second flared beaded joint 162B is disposed at a second end 160B of the rung 160. The second embodiment differs from the first embodiment in that the flared beaded joints 162A, 162B have a non-circular cross section. Additionally, the rung 160 has a non-uniform cross section, for example, the cross-sectional shape of the rung 160 is non-uniform. Further, in the second embodiment, the flare of the flared beaded joints 162A, 162B only extends along portions of the circumference of the rung 160 rather than extending 360 degrees about the circumference in the rung 160. In particular, each of the flared beaded joints 162A, 162B include two flared sections disposed at different radial positions on the rung. The second embodiment also differs from the first embodiment in that the inner diameter of each of the flared beaded joints 162A, 162B is greater than an inner diameter of the rung 160.

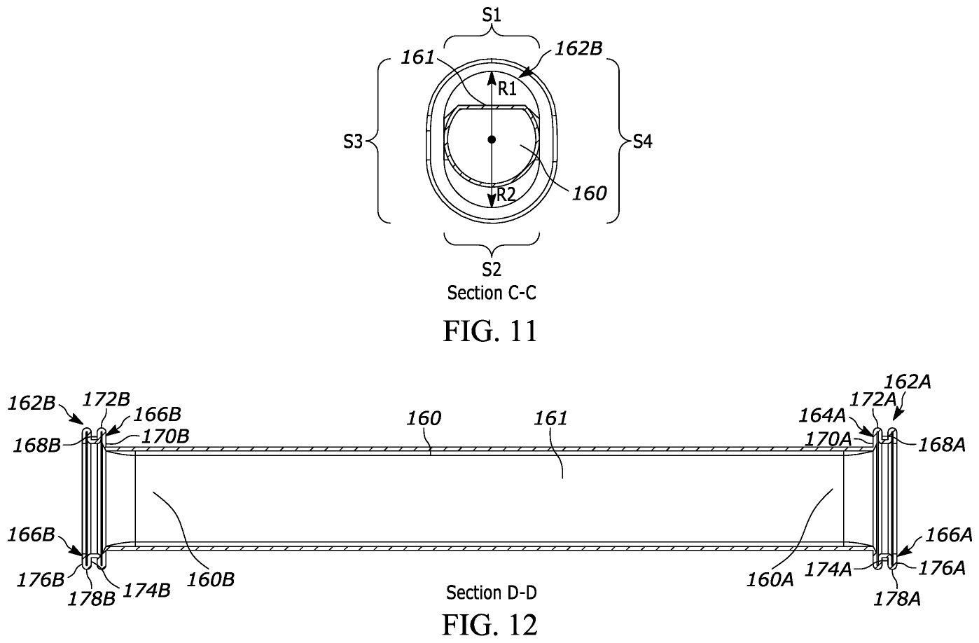

The rung 160 is typically hollow and has an inner diameter D-1, which is illustrated in FIG. 14. The rung 160 includes a flat tread surface 161. The rung 160 has a D-shaped cross-section CS-1 which is illustrated, for example, in FIGS. 10 and 11. Though, it is contemplated that the rung 160 may have any suitable cross-sectional shape such as a triangular, oblong, circular, square, or rectangular shape. In some examples, the rung 160 is a single piece of material, such as a single piece extrusion.

The rung 160 has a non-uniform cross section. In particular, the rung 160 has a first cross section CS-1 disposed a distance from the web of the rail (e.g., along the central portion or a body of the rung 160) and a second cross section CS-2 disposed adjacent the web of the rail (e.g., at the flared beaded joints 162A, 162B). The first cross section CS-1 and second cross section CS-2 are different from one another. In some approaches, the first cross section CS-1 is smaller than the second cross section CS-2. Including a larger cross section adjacent the web of the rail may increase the cantilever strength of the flared beaded joints and, accordingly, the rung to rail joint. In some approaches, the first cross-section CS-1 has a shape that is different than the shape of the second cross section CS-2. For example, the first cross section CS-1 may be circular or D-shaped and the second cross section CS-2 may be oblong.

The first flared beaded joint 162A comprises a first bead 164A and a second bead 166A. The first bead 164A includes a first flange portion 168A and a second flange portion 170A coupled together at a first bend 172A. The first flange portion 168A of the first bead 164A is annular in shape and comprises a flat disc with an open central portion.

The second bead 166A includes a first flange portion 174A and a second flange portion 176A coupled together at a bend 178A. The bend 178A may be approximately 180 degrees or U-shaped such that the first flange portion 174A of the second bead 166A is approximately parallel to the second flange portion 176A. The first flange portion 174A and the second flange portion 176A of the second bead 166A are annular in shape and comprise a flat disc with an open central portion.

The first flange portion 168A of the first bead 164A, the first flange portion 174A of the second bead 166A, and the second flange portion 176A of the second bead 166A have an inner diameter D-2. As shown in FIG. 14, the inner diameter D-2 is greater than the inner diameter D-1 of the rung 160. D-2 also represents the inner diameter of the second bead 166A, which is also is larger than an inner diameter D-1 of the rung 160.

In some non-limiting examples, a ratio of D-1 to D-2 is between about 0.2 and about 0.8, between about 0.3 and about 0.7, between about 0.4 and about 0.6, and, in some aspects, between about 0.5 and about 0.6. Further, in some examples, D-1 may be between about 0.5 inches and about 5 inches, between about 1 inches and about 4 inches, and, in some aspects, between about 1 inches and about 3 inches. Further, in some examples, D-2 may be between about 1 inches and about 8 inches, between about 1 inches and about 6 inches, or, in some aspects, between about 1 inches and about 5 inches.

The first flared beaded joint 162A includes a first section S1, a second section S2, a third section S3, and a fourth section S4, which are illustrated in FIG. 11. The first section 51 and the second section S2 are flared. The third section S3 and the fourth section S4 are not flared. Because there is no flare formed in a portion of the first flared beaded joint 162A, the percent elongation of the rung material may be reduced.

In the first flared section 51 and the second flared section S2, the first bend 172A is less than 180 degrees and may be between about 100 degrees and about 170 degrees, between about 105 degrees and about 165 degrees, or, in some aspects, between about 110 degrees and about 160 degrees. Accordingly, the second flange portion 170A is disposed at an angle relative to the first flange portion 168A and/or relative to the web of the rail to flare the first end 160A of the rung 160. In some approaches, the second flange portion 170A is disposed at an angle between about 10 degrees and about 80 degrees, between about 15 degrees and about 75 degrees, between about 20 degrees and about 60 degrees relative to the first flange portion 168A and/or relative to the web of the rail.

In the third section S3 and the fourth section S4, the first bend 172A is approximately 180 degrees. Accordingly, the second flange portion 170A is not disposed at an angle relative to the first flange portion 168A such that the first flange portion 168A is approximately parallel to the second flange portion 170A.

The first section S1 is disposed at a first radial position R1. The second section S2 is disposed at a second radial position R2. The first radial position R1 and the second radial position R2 are illustrated in FIG. 11. The first flared section 51 and the second flared section S2 may be oriented in any suitable manner depending, for example, on the loading on the rung 160. In some examples, the first flared section 51 and the second flared section S2 may be located where the stresses on the rung are the greatest. Further, in some examples, the rung 160 may have more than two flared sections disposed at various radial positions along the first flared beaded joint 162A. The first radial position R2 may be disposed at a 180-degree radial angle relative to the first radial position R1 such that the first radial position R1 is disposed opposite the second radial position S2. In one example, the first radial position R1 is at the top of the rung 160 and the second radial position R2 is at the bottom of the rung 160.

The cross-sectional shape of the first flared beaded joint 162A is non-circular. In some examples, the first flared beaded joint 162A is generally oblong. The second cross-section CS-2 of the first flared beaded joint 162A is different than the second cross-section CS-2 of the rung 160. The cross-section CS-2 of the first flared beaded joint 162A is illustrated, for example, in FIGS. 10 and 11. It is contemplated that oblong shape of the first flared beaded joint 162A may also provide twist resistance to prevent or reduce twisting of the rung 160 in the rail.

The second flared beaded joint 162B is generally the same as the first flared beaded joint 162A. Elements of the second flared beaded joint 162B that are similar to those of the first flared beaded joint 162A have been given similar reference numbers with a “B” instead of an “A” and only general differences will be discussed. For example, the first flange portion 168A described in the first flared beaded joint 162A is numbered as 168B in the second flared beaded joint 162B.

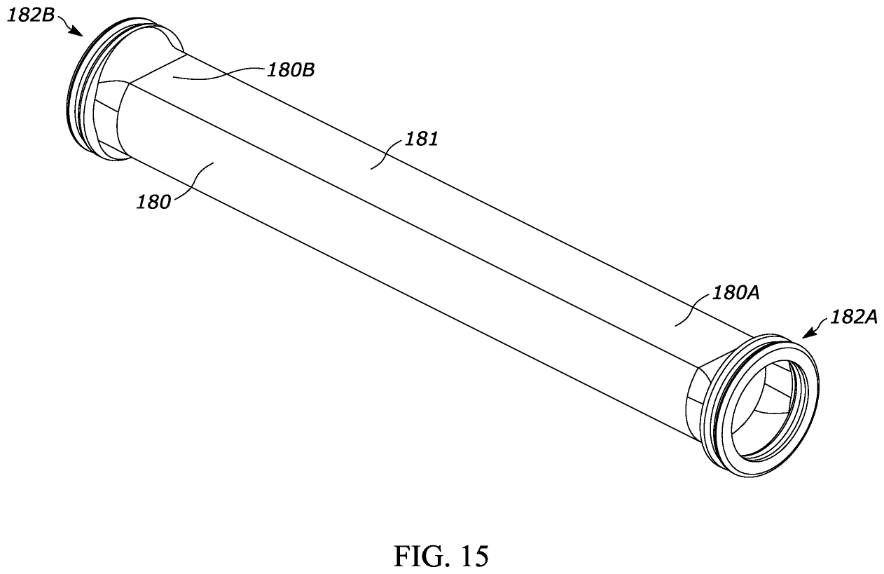

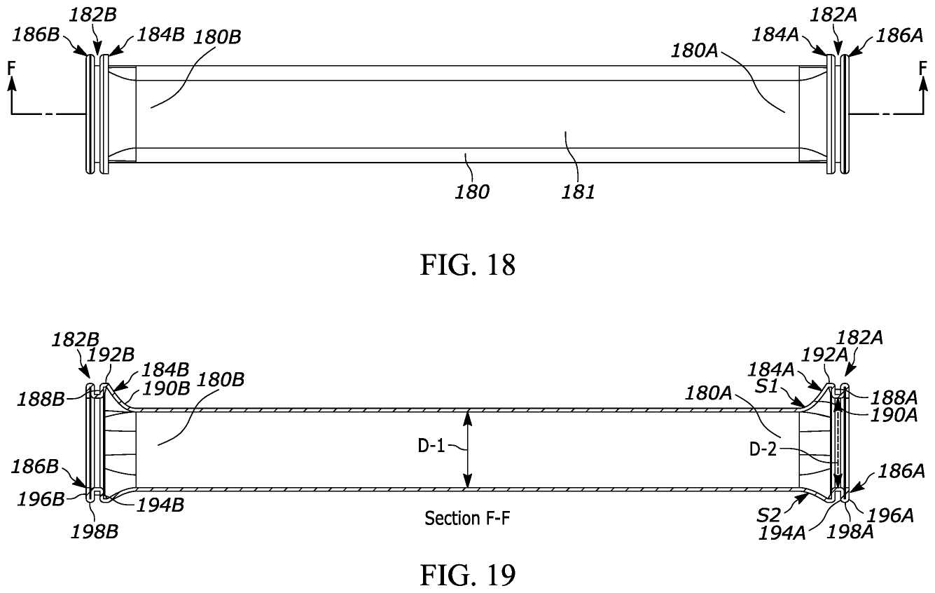

FIGS. 15-19 show a rung 180 with flared beaded joints 182A, 182B, in accordance with a third embodiment. The first flared beaded joint 182A is disposed at a first end 180A of the rung 180. The second flared beaded joint 182B is disposed at a second end 180B of the rung. The third embodiment differs from the first embodiment in that the rung 180 has a D-shaped cross-section, whereas the rung 122 of the first embodiment has a circular shaped cross-section. Further, in the third embodiment, the flare angle is different at different sections of the flared beaded joints 182A, 182B.

The rung 180 is hollow and has an inner diameter D-1, which is illustrated in FIG. 19. The rung 180 includes a flat tread surface 181. The rung 180 has a D-shaped cross-sectional shape which illustrated, for example, in FIG. 17. Though, it is contemplated that the rung 180 may have any suitable cross-sectional shape such as a triangular, oblong, circular, square, or rectangular. In some examples, the rung 180 is a single piece of material, such as a single piece extrusion.

The first flared beaded joint 182A comprises a first bead 184A and a second bead 186A. The first bead 184A includes a first flange portion 188A and a second flange portion 190A coupled together at a first bend 192A. The first bend 180 may be less than 180 degrees such that the first bead 184A is flared. In the third embodiment, the angle of the first bend 192A varies at different positions along the circumference of the rung 180.

The second bead 186A includes a first flange portion 194A and a second flange portion 196A coupled together at a bend 198A. The bend 198A may be approximately 180 degrees or U-shaped such that the first flange portion 194A of the second bead 186A is approximately parallel to the second flange portion 196A such that the second bead 186A is flat.

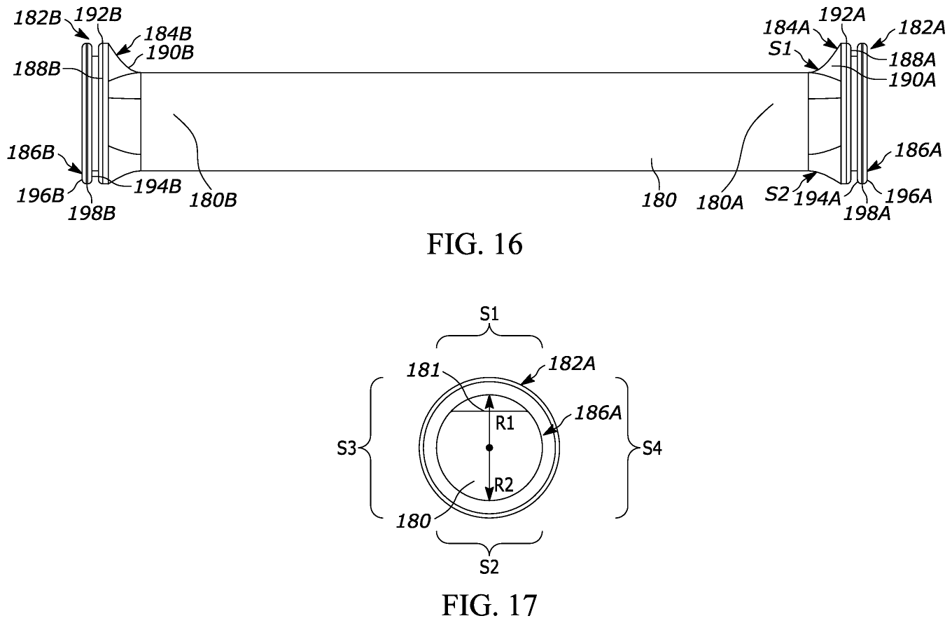

In the first flared beaded joint 182A, the first flange portion 188A of the first bead 184A is annular in shape and comprises a flat disc with an open central portion. Additionally, the first flange portion 194A and the second flange portion 196A of the second bead 186A are annular in shape. The first flange portion 188A of the first bead 184A, the first flange portion 194A of the second bead 186A, and the second flange portion 196A of the second bead 186A have an inner diameter D-2. As shown in FIG. 16, the inner diameter D-2 is greater than the inner diameter D-1 of the rung 180. D-2 also represents the inner diameter of the second bead 186A, which is also is larger than an inner diameter D-1 of the rung 180.

In some non-limiting examples, a ratio of D-1 to D-2 is between about 0.3 and about 0.9, between about 0.3 and about 0.8, between about 0.4 and about 0.8, and, in some aspects, between about 0.5 and about 0.7. Further, in some examples, D-1 may be between about 0.5 inches and about 5 inches, between about 1 inches and about 4 inches, and, in some aspects, between about 1 inches and about 3 inches. Further, in some examples, D-2 may be between about 1 inches and about 8 inches, between about 1 inches and about 6 inches, or, in some aspects, between about 1 inches and about 5 inches.

The first flared beaded joint 182A includes a first section S1, a second section S2, a third section S3, and a fourth section S4, which are illustrated in FIG. 17. The first section 51 and the second section S2 are flared. The flare angle of the first section S1 is different than the flare angle of the second section S2. In some examples, the flare angle of the. The third section S3 and the fourth section S4 are not flared.

In the first flared section S1, the first bend 192A is less than 180 degrees and may be between about 105 degrees and about 165 degrees, between about 110 degrees and about 160 degrees or, in some aspects, between about 120 degrees and about 150 degrees. Accordingly, the second flange portion 190A is disposed at an angle relative to the first flange portion 188A and/or relative to the web of the rail to flare the first end 180A of the rung 180. In some approaches, the second flange portion 190A is disposed at a first angle. The first angle may be between about 15 degrees and about 75 degrees, between about 20 degrees and about 70 degrees, or, in some aspects, between about 30 degrees and about 60 degrees relative to the first flange portion 188A and/or relative to the web of the rail.

In the second flared section S2, the first bend 192A is less than 180 degrees and may be between about 105 degrees and about 175 degrees, between about 125 degrees and about 175 degrees, or, in some aspects, between about 145 degrees and about 175 degrees. Accordingly, the second flange portion 190A is disposed at a second angle relative to the first flange portion 188A and/or relative to the web of the rail to flare the first end 180A of the rung 180. The second angle may be different than the first angle. In some examples, the first angle is smaller than the second angle. In some approaches, the second angle between about 5 degrees and about 75 degrees, between about 5 degrees and about 55 degrees, or, in some aspects, between about 5 degrees and about 35 degrees relative to the first flange portion 188A and/or relative to the web of the rail.

In the third section S3 and the fourth section S4, the first bend 192A is approximately 180 degrees. Accordingly, the second flange portion 190A is not disposed at an angle relative to the first flange portion 188A such that the first flange portion 188A is approximately parallel to the second flange portion 190A.

The first section S1 is disposed at a first radial position R1. The second section S2 is disposed at a second radial position R2. The first radial position R1 and the second radial position R2 are illustrated in FIG. 17. The first flared section S1 and the second flared section S2 may be oriented in any suitable manner depending, for example, on the loading on the rung 180. Further, in some examples, the rung 180 may have more than two flared sections disposed at various radial positions along the first flared beaded joint 182A. The first radial position R2 may be disposed at a 180-degree radial angle relative to the first radial position R1 such that the first radial position R1 is disposed opposite the second radial position S2. In one example, the first radial position R1 is at the top of the rung 180 and the second radial position R2 is at the bottom of the rung 180.

The cross-sectional shape of the first flared beaded joint 182A is generally circular. The cross-sectional shape of the first flared beaded joint 182A is illustrated, for example, in FIG. 17.

The second flared beaded joint 182B is generally the same as the first flared beaded joint 182A. Elements of the second flared beaded joint 182B that are similar to those of the first flared beaded joint 182A have been given similar reference numbers with a “B” instead of an “A” and only general differences will be discussed. For example, the first flange portion 188A described in the first flared beaded joint 182A is numbered as 188B in the second flared beaded joint 182B.

In the third embodiment, the flare that is present in the first beads 184A, 184B of the flared beaded joints 182A, 182B extends 360 degrees around the perimeter of the rung 122. Accordingly, as illustrated in FIG. 17, the cross-sectional shape of the flared beaded joints 140A, 140B is generally circular.

Any aspects of the various illustrated embodiments may be combined to form new combinations. Further, any of the features of the embodiments of the flared beaded joints or rungs described herein and depicted in FIGS. 1-19 may be combined in any manner.

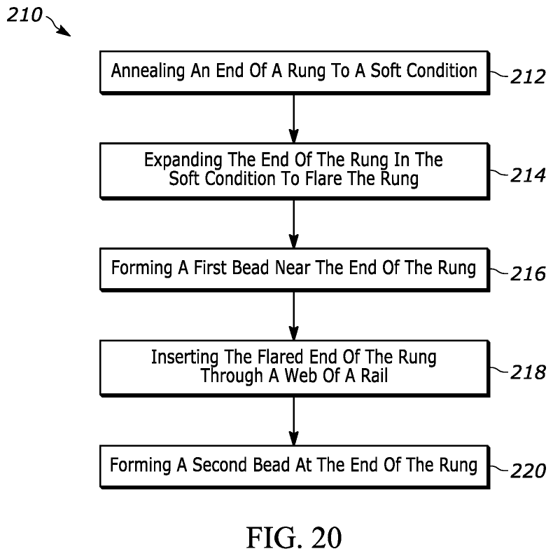

Turning to FIG. 20, an exemplary method 210 of forming a flared beaded joint on a rung is provided. The rung may be made of a metallic material. In one example, the rung is made of aluminum or an aluminum alloy.

At block 212, the method 210 includes annealing an end of a rung to a soft condition. In one example, the end of the rung may be inserted into an induction coil, for example, at a predetermined time and power level to anneal the end of the rung to a soft condition. In such an example, only a portion of the rung at an end of the rung is softened, leaving a remainder of the rung in a hard condition. In one example, a few inches at the ends of the rung may be softened while the central portion of the rung is not.

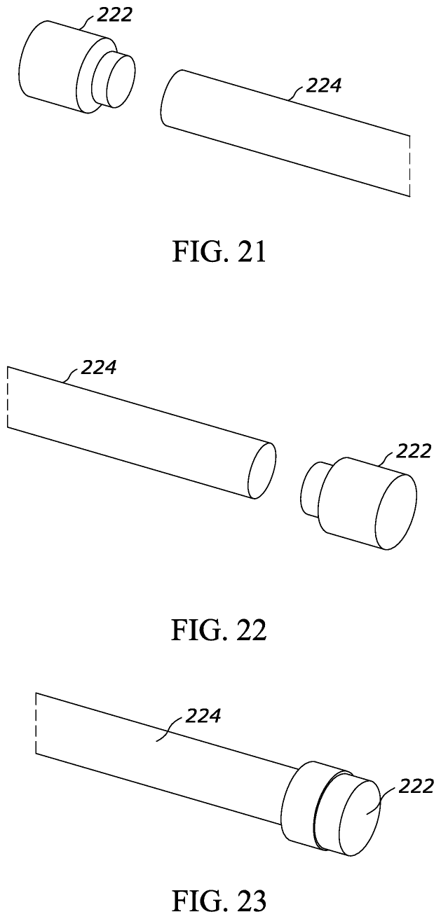

At block 214, the method 210 includes expanding the end of the rung in the soft condition to flare the rung. Any suitable device may be used to expand the end of the rung. An example of a suitable device includes, for example, a mandrel. FIGS. 21-23 illustrate an exemplary mandrel 222. As shown, the mandrel 222 may be inserted into an open end of a rung 224 while the rung is in a soft condition. In this manner, the mandrel 222 expands the open end of the rung 224 to introduce a flare or taper or otherwise expand the cross-section of the rung.

At block 216, the method 210 includes forming a first bead near the end of the rung. In some examples, the first bead is the first bead 144A described in the first embodiment. In other examples, the first bead may be the first bead 164A described in the second embodiment. In yet other examples, the first bead may be the first bead 184A described in the second embodiment. The first bead may be formed in any suitable manner.

At block 218, the method 210 includes inserting the flared end of the rung through a web of a rail. The flared end may be inserted through an opening in the web of the rail. The flared end may be inserted such that the first bead abuts an inner side of the web of the rail.

At block 220, the method 210 includes forming a second bead at the end of the rung. In some examples, the second bead 152A is the second bead described in the first embodiment. In other examples, the second bead is the second bead 166A described in the second embodiment. In yet other examples, the second bead is the second bead 186A described in the third embodiment. The second bead may be formed in any suitable manner.

It is contemplated that devices or tooling may be used to perform steps 212-220 at the same time on both ends of the rung.

The ladders, components, and/or accessories described herein may be formed of a variety of materials and using a variety of manufacturing techniques. Such materials may include, e.g., metals, plastics and other polymers, and/or composite materials. In addition, some portions of the ladder's components may be formed of one material and one or more other components or accessories may be formed of another similar, or entirely distinct material. In some configurations, the rails of the ladders may be formed of composite material such as fiberglass or fiberglass reinforced plastic (FRP) and may be manufactured via a pultrusion process. FRP materials may include various plastic resins, such as polyurethane or polyethylene, or may include various glass materials. It is contemplated that adjusting the FRP formula to use different material combinations may reduce material weight and/or cost. The rails may also be formed of a metal material such as aluminum or aluminum alloys and manufactured via an extrusion process. After extrusion or pultrusion, the ladder rails are typically cut to length. For box-shaped rails, a computerized numerical control (CNC) machine may machine or form one or more holes in the rails. For rails of other shapes, such as C-shaped or I-beam shaped rails, other tools such as a punch press may be leveraged to punch one or more holes into the rails.

The rungs of the ladders may be formed of composite materials such as fiberglass or carbon fiber. In some approaches, the rungs may also be formed of meatal materials such as magnesium, magnesium alloys, aluminum, or aluminum alloys. The rungs may be manufactured, for example, via an extrusion process and cut to length. The rungs may take a variety of shapes and may be, for example, rounded, D-shaped, or triangular. Further, the rungs may have a hollow or substantially hollow cross-section.

Other accessories and assemblies employed in the ladder, such as feet, locks, ropes, rope pullies, end caps, and/or knee braces may be made of materials such as rubber or plastics like polypropylene or any other suitable plastics. Plastic parts may be injection molded or insert molded. In some approaches, accessories and assemblies such as guide brackets, feet, knee braces, and/or locks, may be formed, extruded or stamped, from metal materials such as aluminum, aluminum alloys, or steel. Rubber feet may be riveted to a base of the ladder. Metal locks may be extruded and then cut to length. Rope pulleys may include extruded metal side portions and plastic round pulleys formed of injection molded plastic, with the side portions and pulley held together by a rivet. End caps may be riveted or snap fit to the ladder during assembly. Similarly, knee-caps may be riveted to the ladder.

In some aspects, a ladder comprises a first rail and a second rail spaced apart from the first rail. Each rail has a web and flanges extending from the web. The ladder further comprises a plurality of rungs attached to and disposed between the first rail and the second rail. At least one rung of the plurality of rungs has a flared bead on an inboard side of the web of the first rail and a flared bead on an inboard side of the web of the second rail.

The at least one rung of the plurality of rungs may have a non-flared bead on an outboard side of the first rail and a non-flared bead on an outboard side of the second rail.

In some aspects, a ladder rung comprises a first side having a flared bead and a non-flared bead adjacent the flared bead. The ladder also comprises a second side having a flared bead and a non-flared bead adjacent the flared bead of the second side.

In some aspects, a method for forming a ladder comprises the steps of: annealing an end of a rung made of aluminum to a soft condition. The method further includes expanding the end of the rung in the soft condition to flare the end of the rung. The method also includes forming a flared bead near the end of the rung. The method further includes inserting the flared end of the rung through a web of a rail until the flared bead contacts an inboard side of the rail. The method also includes forming another bead in the flared end of the rung which extends past the web of the rail on an outboard side of the rung so the flared bead and the other bead clinch the web of the rail.

Those skilled in the art will recognize that a wide variety of other modifications, alterations, and combinations can also be made with respect to the above-described embodiments without departing from the scope of the invention, and that such modifications, alterations, and combinations are to be viewed as being within the ambit of the inventive concept.

What is claimed is:

1. A ladder comprising:
a rail including a first flange spaced from a second flange by a web, the web having a first side and a second side; and
at least one rung coupled to the web of the rail via a flared beaded joint, the flared beaded joint includes a first bead and a second bead, the first bead is disposed the first side of the web and the second bead is disposed on the second side of the web, the first bead including a first flange portion and a second flange portion, the first flange portion directly abutting the first side of the web and at least a portion of the second flange portion disposed at an angle relative to the first flange portion to flare an end of the at least one rung.

2. The ladder of claim 1, wherein at least a portion of the flared beaded joint has a flare that extends 360 degrees around a perimeter of the at least one rung.

3. The ladder of claim 1, wherein the first flange portion is disposed approximately parallel to the web.

4. The ladder of claim 1, wherein the second flange is disposed at an angle of between about 15 degrees and about 75 degrees relative to the web.

5. The ladder of claim 1, wherein the first flange portion is an annular ring having an inner diameter that is approximately the same as an inner diameter of the at least one rung.

6. The ladder of claim 1, wherein the first flange portion is an annular ring having an inner diameter that is greater than an inner diameter of the at least one rung.

7. The ladder of claim 1, wherein the second flange is an annular ring.

8. The ladder of claim 1, wherein the first side of the web is on an inner side of the rail, and wherein the second side of the web is on an outer side of the rail.

9. The ladder of claim 1, wherein the at least one rung has a cross-sectional shape that is circular, oval, D-shaped, or triangular.

10. The ladder of claim 1, wherein the second bead includes a first flange portion and a second flange portion, the first flange portion directly abutting the second side of the web and the second flange portion directly abutting the first flange portion.

11. A ladder comprising:
a rail including a web, the web having a first side and a second side; and
at least one rung coupled to the web of the rail via a beaded joint including a first bead on the first side of the web and a second bead on the second side of the web, the first bead including a first annular flange portion that directly abuts the first side of the web and a second annular flange portion, the second annular flange portion including a first section that is disposed at a first angle relative to the first annular flange portion.

12. The ladder of claim 11, wherein the second annular flange portion further includes a second section that is disposed at a second angle relative to the first annular flange portion, and wherein the second section is disposed opposite the first section.

13. The ladder of claim 12, wherein the first angle is different than the second angle and the at least one rung has a first cross section disposed adjacent the web of the rail and a second cross section disposed a distance from the web, wherein the first and second cross sections are different from one another.

14. The ladder of claim 12, wherein the first angle is between about 30 degrees and about 60 degrees, and wherein the second angle is between about 5 degrees and about 35 degrees.

15. The ladder of claim 12, wherein the first section is disposed on a top side of the at least one rung, and wherein the second section is disposed on a bottom side of the at least one rung.

16. The ladder of claim 11, wherein the first annular flange portion has an inner diameter that is greater than an inner diameter of the at least one rung.

17. The ladder of claim 11, wherein the first annular flange portion has an inner diameter that is approximately the same as the inner diameter of the at least one rung.

18. A ladder comprising:
a first rail having a first web;
a second rail parallel to and spaced from the first rail, the second rail having a second web; and
at least one rung having a first end and a second end, the first end coupled to the first web via a first beaded joint and the second end coupled to the second web via a second beaded joint, the first beaded joint having a first outer flange portion disposed at an angle relative to the first web, and the second beaded joint having a second outer flange portion disposed at an angle relative to the second web.

19. The ladder of claim 18, wherein the first beaded joint further includes a first inner flange portion that directly abuts the first web, and wherein the second beaded joint further includes a second inner flange portion that directly abuts the second web.

20. The ladder of claim 19, wherein the first beaded joint further includes a first U-shaped bend that couples the first inner flange portion to the first outer flange portion, and wherein the second beaded joint further includes a second U-shaped bend that couples the second inner flange portion to the second outer flange portion.
